(19) United States
(12) Patent Application Publication
(10) Pub. No.: US 2024/0322281 A1
(43) Pub. Date: Sep. 26, 2024

(54) METHOD FOR MANUFACTURING BIPOLAR PLATES

(71) Applicant: Arkema France, Colombes (FR)

(72) Inventors: Marie HUZAR-EA, Colombes (FR); Stephane BIZET, Serquigny (FR)

(21) Appl. No.: 18/578,769

(22) PCT Filed: Jul. 13, 2022
(86) PCT No.: PCT/FR2022/051408

§ 371 Date: Jan. 12, 2024

(30) Foreign Application Priority Data
Jul. 21, 2021 (FR) FR21.07855

(51) Int. Cl. H01M 10/54; C25B 11/036; C25B 11/04; H01M 4/86; H01M 4/88

(52) U.S. Cl. CPC H01M 10/54; C25B 11/036; C25B 11/04; H01M 4/8631; H01M 4/8652; H01M 4/8875; H01M 2004/8694

(57) ABSTRACT

The present invention relates to a process for the manufacture of a bipolar plate composition. The invention also relates to processes for the manufacture of bipolar plates by injection, extrusion or compression, starting from said composition, and also to the bipolar plates obtained by these processes.

### TECHNICAL FIELD

The present invention relates to a process for the manufacture of a bipolar plate composition. The invention also relates to processes for the manufacture of bipolar plates by injection, extrusion or compression, starting from said composition, and also to the bipolar plates obtained by these processes.

### TECHNICAL CONTEXT

Bipolar plates are used in fuel cells, electrolysers and redox flow batteries. They can be produced from various materials: metallic bipolar plates, graphite plates and carbon-polymer composite plates.

The principle of bipolar plates based on organic composite materials is based on the use of conductive fillers (carbon, graphite, and the like) dispersed in a thermoplastic or thermosetting polymer. The fillers will provide the bipolar plates with the electrical conductivity necessary for collecting the current and the polymer matrix will provide their satisfactory mechanical strength required for the assembly of the various elements.

Carbon-polymer composite bipolar plates exhibit advantageous properties: high electrical conductivity, good corrosion resistance, good performance qualities at high temperatures and good mechanical properties, together with a relatively low manufacturing cost. In these composite bipolar plates, a thermosetting or thermoplastic polymer is used as a matrix for a carbon-based filler chosen from graphite, carbon fibers, carbon black or carbon nanotubes. Although the electrical performance of composite bipolar plates is mainly determined by the carbon-based filler, the material of the polymer matrix also influences the electrical behavior of the composite.

Thermosetting polymer-graphite composites are preferred materials for the manufacture of bipolar plates. However, composite materials based on thermoplastic polymers, in particular thermoplastics stable at high temperatures, have already been used in the manufacture of bipolar plates, due to their ability to be injection molded or extruded, which makes them more suitable for automated manufacture. Such composites have been prepared using polyphenylene sulfide (PPS) or polyether sulfone (PES) containing graphite powder, as reported by Radhakrishnan, S. et al. in the publication: “High-temperature, polymer-graphite hybrid composites for bipolar plates: Effect of processing conditions on electrical properties”, Journal of Power Sources, 2006, Vol. 163, pages 702-707.

The publication of Mighri F. et al., “Electrically conductive thermoplastic blends for injection and compression molding of bipolar plates in the fuel cell application”, Polymer Engineering and Science, 2004, Vol. 44, No. 9, describes bipolar plates made by compression and injection processes starting from graphite, carbon black and polypropylene or polyphenylene sulfide.

The main properties desired for bipolar plates for fuel cells are: high electronic and thermal conductivities, good mechanical properties, such as flexural properties, and high gas barrier properties.

There exists a need to provide a process for the manufacture of a composition for a bipolar plate, said composition exhibiting a good compromise between these properties, and said process being compatible with the manufacturing processes, such as injection, thermocompression or extrusion.

### SUMMARY OF THE INVENTION

According to a first aspect, the invention relates to a process for the manufacture of a composition for a bipolar plate, said process comprising the following stages:
providing a composite mixture based on at least one carbon-based conductive filler and on polymer(s),
incorporating graphite and a polymer binder in said composite mixture.

Characteristically, said composite mixture results from the recycling of lithium-ion batteries.

In one embodiment, the recycling of lithium-ion batteries is carried out by a process chosen from physical separation, pyrometallurgy, hydrometallurgy or a combination of these.

Preferably, the various components of the cell (cathode/anode/separator) are dismantled before they are ground.

According to one embodiment, said at least one carbon-based conductive filler is graphite used as an active filler in the lithium-ion battery anode.

According to one embodiment, said carbon-based conductive filler is a mixture of graphite and of another carbon-based conductive filler, such as carbon black or carbon nanotubes, present in the formulation of the Li-ion battery anode or cathode.

According to one embodiment, said polymer participating in the composition of said composite mixture is a fluoropolymer, a water-soluble thickening polymer (such as, for example, carboxymethyl cellulose), a polyolefin elastomer (such as, for example, a styrene-butadiene rubber), an acrylic resin (such as, for example, carboxylated acrylic polymers) or a mixture of several of these components, including a mixture of different fluoropolymers.

According to another aspect, the invention relates to a process for the manufacture of a bipolar plate, comprising the following stages:
preparing a composition according to the process described above, and
subjecting said composition to injection molding.

According to another aspect, the invention relates to a process for the manufacture of a bipolar plate, comprising the following stages:
preparing a composition according to the process described above, and
subjecting said composition to compression molding.

According to another aspect, the invention relates to a process for the manufacture of a bipolar plate, comprising the following stages:
preparing a composition according to the process described above, and
subjecting said composition to a continuous extrusion process.

The invention additionally relates to bipolar plates obtained by the processes described above or comprising the composition described above.

The present invention makes it possible to overcome the disadvantages of the state of the art. More particularly, it provides a process for the manufacture of compositions, which compositions can be easily employed for the manufacture of bipolar plates.

The advantages of this approach employing a composite mixture resulting from the recycling of lithium-ion batteries are those of benefiting from the good dispersion of the polymer binder in the recycled carbon-based conductive filler/polymer mixture, which makes it possible to improve the dispersion of the carbon-based filler in the bipolar plate. This makes it possible to improve the mechanical strength, the gas barrier properties and the conductivity.

In the case of the manufacture of a bipolar plate by a process requiring a low viscosity (injection) of the polymer-graphite mixture, another advantage originates from the difference in particle size between the graphite used for the bipolar plate and the graphite used in a Li-ion battery anode. The first is bigger (typically having a volume-average diameter (Dv50) ranging from 50 to 150 μm) than the second (typically having a Dv50 in the vicinity of 20 μm and less than 40 μm). This difference makes it possible to improve the transverse electrical conductivity by virtue of the smaller graphite particles, which will be inserted into the interstices left by the bigger graphite particles, while limiting the viscosification of the mixture, conferring on it good implementation of the bipolar plate.

Moreover, the fact that the recycled graphite has experienced a first life in a battery has made it possible for it to be covered by a solid electrolyte interface (SEI). This SEI layer is composed of inorganic elements (LiF, Li₂O₂, Li₂CO₃) and also of polymer fractions resulting from the decomposition of the solvents of electrolytes. Consequently, this SEI layer partakes of a better flexibility and crack resistance, conferring on the recycled graphite the ability to improve the mechanical properties of the bipolar plate.

### DESCRIPTION OF EMBODIMENTS OF THE INVENTION

The invention is described in detail below.

The percentages shown in the text are percentages by weight.

A subject matter of the invention is the use of a conductive fillers/polymers mixture resulting from the recycling of lithium-ion batteries for the manufacture of bipolar plates.

According to a first aspect, the invention relates to a process for the manufacture of a composition for a bipolar plate, said process comprising the following stages:
providing a composite mixture based on at least one carbon-based conductive filler and on polymer(s) (component A),
incorporating graphite (component B) and a polymer binder (component C) in said composite mixture,

characterized in that said composite mixture results from the recycling of lithium-ion batteries.

According to various implementations, said process comprises the following features, if appropriate combined.

### Component A

According to one embodiment, said composite mixture is prepared by a process for the recycling of lithium-ion batteries chosen from pyrometallurgy, hydrometallurgy, physical separation based on characteristics of the materials, such as particle size, density, magnetic or electrical properties, such as flotation, or their combination.

The battery to be recycled is dismantled in order to recover the polymers, the carbon-based fillers and the noble metals of the electrodes. Advantageously, the batteries which are recycled are those having an NMC (nickel-manganese-cobalt) or NCA (nickel-cobalt-aluminum) cathode and a graphite anode.

According to one embodiment, the components of a lithium-ion battery: cathode/separator/anode, are physically separated, the cathode and the anode are ground, and then the hydrometallurgy stages are carried out in order to selectively recover materials, in particular cobalt and nickel. The hydrometallurgy residues consist of carbon-based conductive fillers and polymers, such as PVDF, resistant to the leaching and reprecipitation stages, and thus being able to be reused according to the present invention.

According to another embodiment, the components of a lithium-ion battery: cathode/separator/anode, are physically separated, the cathode and the anode are ground and then flotation or air jet sieving is carried out, making it possible to recover the carbon-based conductive fillers and the low density and hydrophobic polymer binders, thus separated from the active metal fillers and the denser residues of metal current collectors. The recycling process leads to the recovery of the carbon-based fillers which are associated with thermoplastic polymers, that is to say the binders of the electrodes.

Depending on the appearance of the recycled carbon-based conductive fillers/polymers composite mixture (flakes, coarse powder), the process according to the invention can comprise a preliminary stage which consists in grinding, redispersing and sieving said mixture in order to obtain a powder having a particle size of 500 μm maximum, preferentially of less than 200 μm.

According to one embodiment, in the case where a physical dismantling with cathode/separator/anode separation has been carried out beforehand, a recombination of the carbon-based conductive fillers/polymers powders resulting from the cathode and the anode is carried out by a dry powder mixing process with an item of equipment such as a ribbon or paddle mixer. It is possible to carry out this recombination in the molten state by an extrusion process which makes it possible to obtain friable scales or granules which have to be subsequently reground.

According to one embodiment, the cell or the module is ground without carrying out a prior dismantling. It is then possible to recover a mixture of carbon-based conductive fillers and polymers, either after one or more physical separation stage(s) as described above or as a hydrometallurgy process residue.

According to one embodiment, a pyrometallurgy stage is carried out in order to remove the polymers present. Only the carbon-based conductive fillers are then recovered in order to be used according to the invention.

According to one embodiment, said at least one carbon-based conductive filler is graphite used as an active filler in the lithium-ion battery anode.

According to one embodiment, said carbon-based conductive filler is a mixture of graphite and of another carbon-based conductive filler, such as carbon black, carbon nanotubes or carbon fibers (for example, vapor-grown carbon fibers or VGCFs), present in the formulation of the Li-ion battery anode or cathode.

According to one embodiment, said polymer participating in the composition of said composite mixture is a fluoropolymer, such as, for example, polyvinylidene fluoride (PVDF) or polytetrafluoroethylene (PTFE), a water-soluble thickening polymer, such as, for example, carboxymethyl cellulose, a polyolefin elastomer, such as, for example, a styrene-butadiene rubber, an acrylic resin or a mixture of several of these components, including a mixture of different fluoropolymers.

According to one embodiment, said fluoropolymer present in the component A contains, in its chain, at least one monomer chosen from compounds containing a vinyl group capable of opening in order to polymerize and which contains, directly attached to this vinyl group, at least one fluorine atom, a fluoroalkyl group or a fluoroalkoxy group. According to one embodiment, this monomer can be vinyl fluoride, vinylidene fluoride, trifluoroethylene, chlorotrifluoroethylene, 1,2-difluoroethylene, tetrafluoroethylene, hexafluoropropylene; perfluoro(alkyl vinyl) ethers, such as perfluoro(methyl vinyl) ether, perfluoro(ethyl vinyl) ether or perfluoro(propyl vinyl) ether; perfluoro(1,3-dioxole); perfluoro(2,2-dimethyl-1,3-dioxole); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂),CH₂OCF═CF₂ in which n is 1, 2, 3, 4 or 5; the product of formula R₁CH₂OCF═CF₂ in which R₁ is hydrogen or F(CF₂)ₘ and m is 1, 2, 3 or 4; the product of formula R₂OCF═CH₂ in which R₂ is F(CF₂)ₚ and p is 1, 2, 3 or 4; perfluorobutylethylene; 3,3,3-trifluoropropene or 2-trifluoromethyl-3,3,3-trifluoro-1-propene.

The fluoropolymer can be a homopolymer or a copolymer. The copolymer can also comprise nonfluorinated monomers, such as ethylene.

According to one embodiment, the fluoropolymer is a polymer comprising units resulting from vinylidene fluoride, and is preferably chosen from polyvinylidene fluoride homopolymer and copolymers comprising vinylidene fluoride units and units resulting from at least one other comonomer which can copolymerize with vinylidene fluoride.

According to one embodiment, the fluoropolymer present in the component A is a vinylidene fluoride homopolymer.

According to one embodiment, the fluoropolymer is a copolymer comprising vinylidene fluoride (VDF) units and units resulting from one or more monomers. These other monomers are chosen from the list: vinyl fluoride; trifluoroethylene; chlorotrifluoroethylene; 1,2-difluoroethylene, tetrafluoroethylene; hexafluoropropylene; perfluoro(alkyl vinyl) ethers, such as perfluoro(methyl vinyl) ether, perfluoro(ethyl vinyl) ether or perfluoro(propyl vinyl) ether; perfluoro(1,3-dioxole); perfluoro(2,2-dimethyl-1,3-dioxole); the product of formula CF₂—CFOCF₂CF(CF₃)OCF₂CF₂X in which X is SO₂F, CO₂H, CH₂OH, CH₂OCN or CH₂OPO₃H; the product of formula CF₂—CFOCF₂CF₂SO₂F; the product of formula F(CF₂),CH₂OCF—CF₂ in which n is 1, 2, 3, 4 or 5; the product of formula R′CH₂OCF═CF₂ in which R′ is hydrogen or F(CF₂)_{z} and z is 1, 2, 3 or 4; the product of formula R″OCF═CH₂ in which R″ is F(CF₂)_{z} and z is 1, 2, 3 or 4; perfluorobutylethylene; 3,3,3-trifluoropropene or 2-trifluoromethyl-3,3,3-trifluoro-1-propene.

Among these VDF comonomers, hexafluoropropylene is preferred. The VDF copolymers can also comprise nonfluorinated monomers, such as ethylene.

In the VDF copolymers, the content by weight of the VDF units is at least 50%, preferably at least 60%, more preferably greater than 70% and advantageously greater than 80%.

According to one embodiment, the fluoropolymer is functionalized in all or part, which makes it possible for it to improve the adhesion to metal. In this case, the fluoropolymer comprises monomer units carrying at least one carboxylic acid or hydroxyl function.

According to one embodiment, the functional group carries a carboxylic acid function. In this case, the monomer unit carrying at least one carboxylic acid function is chosen from acrylic acid, methacrylic acid and acryloyloxypropyl succinate.

According to one embodiment, the units carrying the carboxylic acid function additionally comprise a heteroatom chosen from oxygen, sulfur, nitrogen and phosphorus.

According to one embodiment, the functional group carries a hydroxyl function. In this case, the monomer unit carrying at least one carboxylic acid function is chosen from hydroxyethyl (meth)acrylate, hydroxypropyl (meth)acrylate and hydroxyethylhexyl (meth)acrylate.

According to one embodiment, the content of functional groups of the fluoropolymer is at least 0.01 mol %, preferably at least 0.1 mol %, and at most 15 mol %, preferably at most 10 mol %.

The fluoropolymer present in the component A can be a mixture of one or more polymers described above, for example a mixture of a PVDF homopolymer and of at least one VDF copolymer, a mixture of at least two VDF copolymers, a mixture of a functionalized PVDF and of a PVDF homopolymer or a mixture of a functionalized PVDF and of a VDF copolymer.

According to a preferred embodiment, the component A can also comprise silicon. Preferably, the silicon results from the recycling of the anode.

According to one embodiment, the recycled carbon-based conductive filler/polymer mixture exhibits the following composition by weight:
60% to 100% of graphite,
0% to 20% of silicon
0% to 10% of water-soluble thickener,
0% to 10% of polyolefin elastomer,
0% to 10% of acrylic resin,
0% to 10% of fluoropolymer(s),
0% to 40% of polyolefin (such as polyethylene and/or polypropylene),
0% to 10% of a second carbon-based conductive filler, the sum of all these percentages being 100%.

According to one embodiment, the recycled carbon-based conductive filler/polymer mixture exhibits the following composition by weight:
70% to 100% of graphite,
0% to 10% of water-soluble thickener,
0% to 10% of polyolefin elastomer,
0% to 10% of acrylic resin,
0% to 10% of fluoropolymer(s),
0% to 40% of polyolefin (such as polyethylene and/or polypropylene),
0% to 10% of a second carbon-based conductive filler, the sum of all these percentages being 100%.

According to one embodiment, the ratio by weight of the water-soluble thickener to the polyolefin elastomer ranges from 1:9 to 9:1, and is preferably 1:4.

Advantageously, the graphite present in the component A exhibits a particle size, expressed as volume-average diameter (Dv50), ranging from 1 to 40 μm, preferentially from 5 to 30 μm. The Dv50 is the particle diameter at the 50th percentile of the cumulative particle size distribution. This parameter can be measured by laser particle size analysis.

Preferably, the component A comprises graphite having a particle size, expressed as volume-average diameter (Dv50), which is lower than the volume-average diameter (Dv50) of the graphite constituting the component B described below.

Component B The second component of the bipolar plate composition according to the invention is graphite. It is the major component by weight of the composition, present at 50% or more. Advantageously, the graphite constituting the component B has a volume-average diameter (Dv50) ranging from 50 to 500 μm, preferentially from 75 to 150 μm.

### Component C

The third component of the bipolar plate composition according to the invention is a polymer acting as a binder. Said polymer can be a polyolefin (for example: polyethylene or polypropylene), a fluoropolymer (PVDF), polyphenylsulfone, polyethersulfone, a phenolic resin, a vinyl ester resin, an epoxy resin or a liquid crystal polymer.

According to one embodiment, said fluoropolymer present in the component C contains, in its chain, at least one monomer chosen from compounds containing a vinyl group capable of opening in order to polymerize and which contains, directly attached to this vinyl group, at least one fluorine atom, a fluoroalkyl group or a fluoroalkoxy group. According to one embodiment, this monomer can be vinylidene fluoride.

The fluoropolymer can be a homopolymer or a copolymer. The copolymer can also comprise nonfluorinated monomers, such as ethylene.

According to one embodiment, the fluoropolymer is a polymer comprising units resulting from vinylidene fluoride, and is preferably chosen from polyvinylidene fluoride homopolymer and copolymers comprising vinylidene fluoride units and units resulting from at least one other comonomer which can copolymerize with vinylidene fluoride.

According to one embodiment, the fluoropolymer present in the component C is a vinylidene fluoride homopolymer.

According to one embodiment, the fluoropolymer is a copolymer comprising vinylidene fluoride (VDF) units and units resulting from one or more monomers. These other monomers are chosen from the list: vinyl fluoride; trifluoroethylene; chlorotrifluoroethylene; 1,2-difluoroethylene, tetrafluoroethylene; hexafluoropropylene; perfluoro(alkyl vinyl) ethers, such as perfluoro(methyl vinyl) ether, perfluoro(ethyl vinyl) ether or perfluoro(propyl vinyl) ether; perfluoro(1,3-dioxole); perfluoro(2,2-dimethyl-1,3-dioxole); the product of formula CF₂═CFOCF₂CF(CF₃)OCF₂CF₂X in which X is SO₂F, CO₂H, CH₂OH, CH₂OCN or CH₂OPO₃H; the product of formula CF₂—CFOCF₂CF₂SO₂F; the product of formula F(CF₂),CH₂OCF—CF₂ in which n is 1, 2, 3, 4 or 5; the product of formula R′CH₂OCF═CF₂ in which R′ is hydrogen or F(CF₂), and z is 1, 2, 3 or 4; the product of formula R″OCF═CH₂ in which R″ is F(CF₂), and z is 1, 2, 3 or 4; perfluorobutylethylene; 3,3,3-trifluoropropene or 2-trifluoromethyl-3,3,3-trifluoro-1-propene.

Among these VDF comonomers, hexafluoropropylene is preferred. The VDF copolymers can also comprise nonfluorinated monomers, such as ethylene.

In the VDF copolymers, the content by weight of the VDF units is at least 50%, preferably at least 60%, more preferably greater than 70% and advantageously greater than 80%.

According to one embodiment, the fluoropolymer is functionalized in all or part, which makes it possible for it to improve the adhesion to metal. In this case, the fluoropolymer comprises monomer units carrying at least one carboxylic acid or carboxylic acid anhydride function.

The function is introduced onto the fluoropolymer by a chemical reaction which can be grafting or a copolymerization of the fluoromonomer with a monomer carrying at least one-COOH or carboxylic acid anhydride group and a vinyl function capable of copolymerizing with the fluoromonomer, according to techniques well known to a person skilled in the art.

According to one embodiment, the choice is made, as polar monomers carrying a carboxylic function, of unsaturated mono—and dicarboxylic acids having from 2 to 20 carbon atoms and in particular from 4 to 10 carbon atoms, such as acrylic, methacrylic, maleic, fumaric, itaconic, citraconic, allylsuccinic, cyclohex-4-ene-1,2-dicarboxylic, 4-methylcyclohex-4-ene-1,2-dicarboxylic, bicyclo[2.2.1]hept-5-ene-2,3-dicarboxylic, x-methylbicyclo[2.2.1]hept-5-ene-2,3-dicarboxylic and undecylenic acid, and also their anhydrides.

According to one embodiment, the units carrying the carboxylic acid function additionally comprise a heteroatom chosen from oxygen, sulfur, nitrogen and phosphorus.

According to one embodiment, the content of functional groups of the fluoropolymer is at least 0.01 mol %, preferably at least 0.1 mol %, and at most 15 mol %, preferably at most 10 mol %.

The fluoropolymer present in the component C can be a mixture of one or more polymers described above, for example a mixture of a PVDF homopolymer and of at least one VDF copolymer or a mixture of at least two VDF copolymers.

According to one embodiment, the bipolar plate composition by weight employed in the process according to the invention consists of:
graphite (component B): 50% to 85%,
carbon-based conductive filler+polymer mixture resulting from lithium-ion battery recycling (component A): 1% to 50%, preferentially 10-25%,
polymer binder (component C): 5% to 40%, preferentially 10-20%, the sum of these percentages being 100%.

### Processes

According to a first aspect, the invention relates to a process for the manufacture of the composition described above, said process comprising the following stages:
providing a composite mixture based on at least one carbon-based conductive filler and on polymer(s) (component A),
incorporating graphite (component B) and a polymer binder (component C) in said composite mixture, characterized in that said composite mixture results from the recycling of lithium-ion batteries.

The process according to the invention comprises a stage of mixing, in the molten state, the component A with the component C and the component B. This stage makes it possible to formulate an intimate mixture.

According to one embodiment, the powders are mixed in the dry state.

According to one embodiment, the mixing stage is carried out in the molten state by extrusion, for example using a kneader or a twin-screw extruder.

The invention also relates to a bipolar plate composition manufactured by means of the process described above.

### Bipolar Plate

The invention also relates to a bipolar plate comprising the composition described above, in an agglomerated form. A bipolar plate is a plate which separates the elementary cells in fuel cells, electrolysers and redox flow batteries. In general, it has a parallelepipedal shape having a thickness of a few millimeters (typically of between 0.2 and 6 mm) and comprises, on each face, a network of channels for the circulation of gases and fluids. Its functions consist in feeding the fuel cell with gaseous fuel, in discharging the reaction products and in collecting the electrical current produced by the cell.

According to another aspect, the invention relates to a process for the manufacture of a bipolar plate, comprising the following stages:
preparing a composition according to the process described above, and
subjecting said composition to injection molding.

Preferably, the composition for a bipolar plate is subjected to injection molding in powder form.

The process according to the invention can additionally comprise a supplementary stage of grinding this powder, for example by means of a disk mill.

The compositions of the invention are particularly well suited to the manufacture of composite bipolar plates by the injection molding process. The injection molding process consists of several stages. First of all, granules or powders are introduced into an extruder via a feed hopper. Once introduced, the substance is transported in the barrel where it is simultaneously heated, sheared and conveyed toward the mold by the extrusion screw. The substance is held momentarily in the barrel and pressurized before the injection phase. When the appropriate pressure is reached, the substance is injected into a mold having the shape and the dimensions of the final object desired, the temperature of the mold being regulated. The duration of the cycle depends on the size of the parts and on the solidification time of the polymer. Maintaining the substance under pressure once injected into the mold limits the deformation and the shrinkage after removal from the mold. To eject the parts, the portions of the mold are separated, the core is retracted and the ejectors are pushed in order to detach the parts from the surface of the mold.

The injection process has many parameters: temperature of the substance during the plasticization stage, injection rate, injection pressure of the substance, maintenance time and pressure in the mold, temperature of the mold.

In the case of the injection of composite bipolar plates of the invention, the temperature profile applied along the extrusion screw can vary from 100° C. to 280° C. from the feed zone up to the injection head. The temperature of the mold can range from ambient temperature up to 280° C. Several processes for cooling the mold can be used. The substance can be injected into a mold maintained at a temperature between the melting point and the glass transition temperature for a semicrystalline polymer.

Moreover, there exist injection processes for which the temperature of the mold varies during the injection cycle. In this type of process, the substance is first of all injected into a mold, the temperature of which is greater than the melting point for a semicrystalline thermoplastic polymer. This phase promotes the filling of the mold. Subsequently, the mold is cooled to a temperature between the melting point and the glass transition temperature for a semicrystalline polymer, in order to promote crystallization. Commercial versions of these variable mold temperature processes exist. For example, mention may be made of the Roctool, Variotherm and Variomelt technologies.

The other injection parameters, such as injection rate, injection pressure of the substance or maintenance time and pressure in the mold, depend on the geometry of the mold, on its dimensions or on the size and position of the gates.

According to another aspect, the invention relates to a process for the manufacture of a bipolar plate, comprising the following stages:
preparing a composition according to the process described above, and
subjecting said composition to compression molding.

Preferably, the bipolar plate composition is subjected to compression molding in powder form.

The process according to the invention can additionally comprise a stage of grinding this powder, for example by means of a disk mill.

The compression molding of compositions intended to produce bipolar plates can be carried out by introducing said composition into a mold, for example a stainless steel mold, which is subsequently closed and heated to a temperature ranging from 200° C. to 350° C., preferably from 250° C. to 300° C. Subsequently, a compressive force of 300 t to 800 t, preferably of 400 t to 600 t, is applied to the mold, for a mold with dimensions of 100 000 to 150 000 mm². Typically, a compressive force of 500 t is applied when the size of the mold is 130 000 mm² and a compressive force of 300 t is applied when the size of the mold is 44 000 mm². The mold is subsequently cooled to a temperature of 50° C. to 120° C., preferably of 60° C. to 100° C., and the plate is removed from the mold.

According to another aspect, the invention relates to a process for the manufacture of a bipolar plate, comprising the following stages:
preparing a composition according to the process described above, and
subjecting said composition to a continuous extrusion process.

The composition is introduced into an extruder of single-screw or twin-screw type with a flat die, so as to obtain a continuous plate which is subsequently etched.

The invention additionally relates to bipolar plates obtained by the processes described above.

Advantageously, the bipolar plate exhibits at least one of the following characteristics and preferably all these characteristics:
a surface resistivity of less than or equal to 0.01 ohm.cm;
a volume resistivity of less than or equal to 0.03 ohm.cm;
a thermal conductivity of greater than or equal to 10 W/m/K;
a flexural strength of greater than or equal to 25 N/mm²;
a compressive strength of greater than or equal to 25 N/mm².

The flexural strength is measured according to the standard DIN EN ISO 178. The compressive strength is measured according to the standard ISO 604. The thermal conductivity is measured according to the laser flash technique according to the standard DIN EN ISO 821. The surface resistivity is measured by means of four-point probe samples on ground samples having a thickness of 4 mm. The volume resistivity is measured with a two-electrode device and a contact pressure of 1 N/mm² on surfaced samples having a diameter of 13 mm and a thickness of 2 mm.

According to certain embodiments, the bipolar plate exhibits a surface resistivity of less than or equal to 0.008 ohm.cm, or of less than or equal to 0.005 ohm.cm, or of less than or equal to 0.003 ohm.cm, or of less than or equal to 0.001 ohm.cm.

According to certain embodiments, the bipolar plate exhibits a through-plane resistivity of less than or equal to 0.025 ohm.cm, or of less than or equal to 0.02 ohm.cm, or of less than or equal to 0.015 ohm.cm.

According to certain embodiments, the bipolar plate has a thermal conductivity of greater than or equal to 15 W/m/K, or of greater than or equal to 20 W/m/K. According to certain embodiments, the bipolar plate exhibits a flexural strength of greater than or equal to 30 N/mm², or of greater than or equal to 35 N/mm². According to a preferred embodiment, the bipolar plate consists of:
from 50% to 85% of component B as defined in the present invention having a volume-average diameter (Dv50) ranging from 50 to 500 μm,
from 1% to 50% of component A as defined in the present invention and comprising graphite having a particle size, expressed as volume-average diameter (Dv50), ranging from 1 to 40 μm,
from 5% to 40% of component C as defined in the present invention;
the sum of these percentages being 100%.

### Examples

For the preparation of the bipolar plates, a synthetic graphite (Graphite Timrex KS150) having a particle size characterized by a Dv50 of 55 μm and a vinylidene difluoride homopolymer which has a melt viscosity, measured at 232° C. and 100 s⁻¹, of 900 Pa·s were used.

Composition 1 Resulting from the Recycling of a Lithium-Ion Battery Graphite Anode:

The composition 1 resulting from a graphite anode was obtained by a recycling process based on the physical separation of the elements. First of all, the constituent elements of the battery (anode/separator/cathode) were physically separated. The anode was subsequently ground up. Finally, it was subjected to air jet sieving in order to separate copper fragments, graphite and polymer binders. On conclusion of this stage, a powder consisting of 94.0% by weight of graphite, 3.4% by weight of carboxymethyl cellulose (CMC) and 2.6% by weight of a styrene-butadiene elastomer (SBR) was recovered. The graphite in this composition was a synthetic graphite which has a particle size characterized by a Dv50 of 17 μm.

Composition 2 Resulting from the Black Mass of a Lithium-Ion Battery with Graphite Anode and NMC Cathode:

The composition 2 results from the black mass of a lithium-ion battery. It contains the nonmetallic and noninorganic residues, that is to say the graphite, the carbon-based conductive filler of the cathode, the polymer binders of the electrodes (PVDF, CMC, SBR) and the polyolefin of the separator. The constituent elements of the battery (anode/separator/cathode) were first of all shredded and then ground up. Subsequently, the ground material was subjected to the various stages of a hydrometallurgy process in order to dissolve the metal current collectors and the inorganic fillers, such as NMC and boehmite, of the coating of the separator. The residues of the hydrometallurgy process are composed of:
82.7% by weight of graphite resulting from the anode. It has a particle size characterized by a Dv50 of 17 μm.
1.8% by weight of carboxymethyl cellulose (CMC)
1.4% by weight of a styrene-butadiene elastomer (SBR)
4.1% by weight of polyvinylidene fluoride (PVDF) resulting from the cathode
4.1% by weight of carbon black resulting from the cathode
5.9% by weight of polyolefin resulting from the separator

### Composition of the Bipolar Plates Having the Same Content of Binder:

TABLE 1
Composition of the bipolar plates produced

| | | | | Composition 2 |
|---|---|---|---|---|
| | | | Composition 1 | resulting from |
| | | | resulting from | the recycling |
| | Graphite | PVDF | the recycling | of the black |
| | Timrex | Kynar ® | of a Li-ion | mass of a Li-ion |
| | KS150 | 721 | battery anode | battery |
| Example 1 | 63.75% | 15% | 21.25% | |
| Example 2 | 65.25% | 13.5% | | 21.25% |
| Comparative | 83.725% | 16.275% | — | |
| example | | | | |

### Preparation of the Bipolar Plates:

### Premixing of the Composition Used for the Manufacture of the Bipolar Plate:

The constituents of example 1, the Timrex KS150 graphite, the Kynar® 721 PVDF and the composition resulting from the recycling of a lithium-ion battery anode, were premixed using a twin-screw extruder. On conclusion of this mixing stage, very friable granules were obtained. These granules were subsequently ground using a disk mill so as to obtain a powder with an average size Dv50 of less than 500 μm.

The composition of the comparative example was prepared according to the same protocol.

### Manufacture of the Bipolar Plate by Thermocompression:

The manufacture of the bipolar plates was carried out by thermocompression. To do this, a mold with a dimension of 30×30 cm² was filled manually with the composition in powder form. The powder was leveled manually with a metal blade. The mold was closed and brought to 240° C. under a pressure of 150 bar. The amount of powder was adjusted in order to obtain a thickness of approximately 3 mm. The mold was cooled under pressure down to a temperature of 80° C. Once this temperature was reached, the pressure was removed and the plate was withdrawn from the mold.

### Characterization Method:

### Flexural Strength

The flexural strength was measured according to the standard DIN EN ISO 178.

### Results

| | Flexural strength |
|---|---|
| | (MPa) |
| Example 1 | 42 |
| Example 2 | 43 |
| Comparative example | 39 |

As is demonstrated by the results, the bipolar plates according to the present invention exhibit a better flexural strength compared with the comparative example in which there is no graphite resulting from the recycling of a battery.

1. A process for the manufacture of a composition for a bipolar plate, said process comprising the following stages:
providing a composite mixture comprising at least one carbon-based conductive filler and one or more polymer(s) (component A),
incorporating graphite (component B) and a polymer binder (component C) in said composite mixture,
characterized in that said composite mixture results from the recycling of lithium-ion batteries.

2. The process of claim 1, in which the recycling of lithium-ion batteries is carried out by a process chosen from physical separation, hydrometallurgy or a combination there of.

3. The process of claim 1, in which said at least one carbon-based conductive filler is graphite used as an active filler in the lithium-ion battery anode.

4. The process of claim 1, in which said carbon-based conductive filler is a mixture of graphite and of another carbon-based conductive filler, selected from the group consisting of carbon black, carbon nanotubes or carbon fibers.

5. The process of claim 1, in which said polymer of the component A is selected from the groups consisting of one or more fluoropolymers, a water-soluble thickening polymer, a polyolefin elastomer, an acrylic resin and mixtures thereof.

6. The process of claim 5, in which said fluoropolymer is selected from the group consisting of: vinylidene fluoride homopolymers; vinylidene fluoride copolymers and their mixtures; wherein
said vinylidene fluoride copolymer comprises comonomer units resulting from one or more comonomers selected from the group consisting of vinyl fluoride; trifluoroethylene;
chlorotrifluoroethylene; 1,2-difluoroethylene; tetrafluoroethylene; hexafluoropropylene;
perfluoro(alkyl vinyl) ethers; perfluoro(1,3-dioxole); perfluoro(2,2-dimethyl-1,3-dioxole); the product of formula CF₂—CFOCF₂CF(CF₃)OCF₂CF₂X in which X is SO₂F, CO₂H, CH₂OH, CH₂OCN or CH₂OPO₃H; the product of formula CF₂—CFOCF₂CF₂SO₂F; the product of formula F(CF₂),CH₂OCF—CF₂ in which n is 1, 2, 3, 4 or 5; the product of formula R′CH₂OCF═CF₂ in which R′ is hydrogen or F(CF₂), and z is 1, 2, 3 or 4; the product of formula R″OCF═CH₂_in which R″ is F(CF₂), and z is 1, 2, 3 or 4; perfluorobutylethylene; 3,3,3-trifluoropropene; 2-trifluoromethyl-3,3,3-trifluoro-1-propene; acrylic acid; methacrylic acid; hydroxyethyl (meth)acrylate; hydroxypropyl (methacrylate; hydroxyethylhexyl (meth)acrylate;
acryloyloxypropyl succinate; and mixtures thereof.

7. The process of claim 1, in which component A comprises the following composition by weight:
60% to 100% of graphite,
0% to 20% of silicon,
0% to 10% of water-soluble thickener,
0% to 10% of polyolefin elastomer,
0% to 10% of acrylic resin,
0% to 10% of fluoropolymer(s),
0 to 40% polyolefin,
0% to 10% of a second carbon-based conductive filler,
the sum of all these percentages being 100%.

8. The process of claim 1, characterized in that the component A comprises graphite having a particle size, expressed as volume-average diameter (Dv50), which is lower than the volume-average diameter (Dv50) of the graphite constituting the component B.

9. The process of claim 1, in which the graphite present in the component A exhibits a particle size, expressed as volume-average diameter (Dv50), ranging from 1 to 40 μm.

10. The process of claim 1, in which the graphite constituting the component B has a volume-average diameter (Dv50) ranging from 50 to 500 μm.

11. The process of claim 1, in which said polymer binder constituting the component C is selected from the group consisting of a polyolefin, a fluoropolymer, polyphenylsulfone, polyethersulfone, a phenolic resin, a vinyl ester resin, an epoxy resin and a liquid crystal polymer.

12. The process of claim 1, in which the bipolar plate composition by weight employed in the process consists of:
component B: 50% to 85%,
component A: 1% to 50%,
component C: 5% to 40%,
the sum of these percentages being 100%.

13. A process for the manufacture of a bipolar plate, comprising the following stages:
preparing a composition according to the process of claim 1, and
subjecting said composition to injection molding.

14. A process for the manufacture of a bipolar plate, comprising the following stages:
preparing a composition according to the process of claim 1, and
subjecting the composition to compression molding.

15. A process for the manufacture of a bipolar plate, comprising the following stages:
preparing a composition according to the process of claim 1, and
subjecting the composition to a continuous extrusion process.

16. A bipolar plate obtained by the process as claimed in claim 13.

17. A bipolar plate obtained by the process as claimed in claim 14.

18. A bipolar plate obtained by the process as claimed in claim 15.

19. A bipolar plate consisting of:
from 50% to 85% of component B of claim 1 having a volume-average diameter (Dv50) ranging from 50 to 500 μm,
from 1% to 50% of component A of claim 1 and comprising graphite having a particle size, expressed as volume-average diameter (Dv50), ranging from 1 to 40 μm,
from 5% to 40% of component C of claim 1;
the sum of these percentages being 100%.
